(19) United States
(12) Patent Application Publication
(10) Pub. No.: US 2024/0286237 A1
(43) Pub. Date: Aug. 29, 2024

(54) TOOL MEASUREMENT ASSEMBLY FOR A MILL-TURN MACHINE

(71) Applicant: FIVES GIDDINGS & LEWIS, LLC, Fond du Lac, WI (US)

(72) Inventor: Keith A. Eisfeldt, Fond du Lac, WI (US)

(21) Appl. No.: 18/115,304

(22) Filed: Feb. 28, 2023

(51) Int. Cl. B23Q 17/24

(52) U.S. Cl. CPC B23Q 17/2457; B23Q 17/248

(57) ABSTRACT

A tool measurement assembly for a mill-turn machine including a laser tool setter having a laser transmitter that measures an outer surface of a rotary cutting tool held by the mill-turn machine; and a physical stylus tool probe configured to contact a stationary cutting tool held by the mill-turn machine; the tool measurement assembly is configured to mount to the mill-turn machine allowing the tool measurement assembly to move into a measurement position within a workspace.

### TECHNICAL FIELD

The present application relates to machine tools and, more particularly, to mill-turn machines.

### BACKGROUND

Machine tools are used to cut a wide variety of different workpieces. Depending on the type of machining used to form a workpiece, different types of machine tools may be used on one workpiece. For example, milling machines include rotating spindles coupled with a rotary cutting tool used to cut and bore stationary workpieces and turning machines include a stationary cutting element applied to a rotating workpiece. However, as efficiency demands increase, these different cutting techniques have been combined and offered using a common machine tool, often referred to as a mill-turn machine. The additional flexibility of offering both milling and turning operations in one machine may create some challenges for automatic tool measurement.

### SUMMARY

In one implementation, a tool measurement assembly for a mill-turn machine including a laser tool setter having a laser transmitter that measures an outer surface of a rotary cutting tool held by the mill-turn machine; and a physical stylus tool probe configured to contact a stationary cutting tool held by the mill-turn machine; the tool measurement assembly is configured to mount to the mill-turn machine allowing the tool measurement assembly to move into a measurement position within a workspace.

In another implementation, a tool measurement assembly for a mill-turn machine includes a yoke and a rail configured to couple with the mill-turn machine and permit the tool measurement assembly to move into the work envelope; a laser tool setter, attached to the yoke, having a laser transmitter and a laser receiver that measures an outer surface of a rotary cutting tool held by the mill-turn machine; and a physical stylus tool probe, attached to the yoke, that retractably deploys to contact a stationary cutting tool held by the mill-turn machine.

### BRIEF DESCRIPTION OF THE DRAWINGS

FIG. 1 is a perspective view depicting an implementation of a mill-turn machine including a tool measurement assembly;

FIG. 2 is a perspective view depicting a portion of an implementation of a mill-turn machine including a tool measurement assembly;

FIG. 3 is a perspective view depicting a portion of an implementation of a mill-turn machine including a tool measurement assembly;

FIG. 4 is a perspective view depicting a portion of an implementation of a mill-turn machine including a tool measurement assembly;

FIG. 5 is a perspective view depicting a portion of an implementation of a mill-turn machine including a tool measurement assembly; and

FIG. 6 is a perspective view depicting a portion of an implementation of a mill-turn machine including a tool measurement assembly.

### DETAILED DESCRIPTION

A mill-turn machine, capable of both milling and turning machining operations, includes a tool measurement assembly that measures and/or calibrates a tool. The tool measurement assembly can include a laser tool setter and a physical stylus tool probe that are each selectable for measuring the size of cutting tools used by mill-turn machines depending on which type of cutting tool is measured. For example, the laser tool setter can be selected for measuring rotating cutting tools held in a spindle of the mill-turn machine, such as is used for milling operations and the physical stylus tool probe can be selected for measuring stationary cutting tools used for turning operations.

Several challenges exist with respect to using a laser tool setter and a physical stylus tool probe in a mill-turn machine to measure a tool. A laser tool setter may provide highly accurate measurements of a rotating cutting tool held by a spindle. Laser tool setters are typically placed in the workspace where machining operations are carried out on a workpiece and, for milling operations, the setter may not be adversely affected because milling chips tend to be discontinuous and the table holding the workpiece does not aggressively rotate. Also, the rotary cutting tool used with the spindle may have fluted edges the apparent diameter of which depends on the angular position of the cutting tool when it stops. Lasers are highly effective at measuring the outer diameter of such a cutting tool regardless of the angular position of the rotary cutting tool. The spindle can rotate the rotary cutting tool and, while the tool is turning, the laser can measure the tool thereby ensuring the maximum diameter of the tool is determined. However, during turning operations, table rotation can create tough stringy chips and large angular acceleration of the workpiece, each of which can damage the laser tool setter or affect its alignment. Further, the use of fluid during the turning process can interfere with the laser thereby decreasing its accuracy.

Physical stylus tool probes can reliably calibrate or measure stationary cutting tools used in turning operations despite the presence of fluid or stringy chips. But with respect to rotating cutting tools held by spindles, the physical stylus tool probe may inaccurately measure the rotary cutting tool due to the curvature of cutting flutes and the random angular position of the flutes when stopped.

A laser tool setter and physical stylus tool probe can be integrated in a common assembly that is deployed into a workspace such that the assembly is removably placed adjacent to the tool head of the mill-turn machine. It is possible to linearly slide the tool measurement assembly along a rail into the workspace such that position of the assembly and, thereby the laser tool setter and the physical stylus tool probe, is accurately positioned relative to the machine 10. Further, the tool measurement assembly can be removed from the workspace such that disruption created due to machining operations on the workpiece can be minimized.

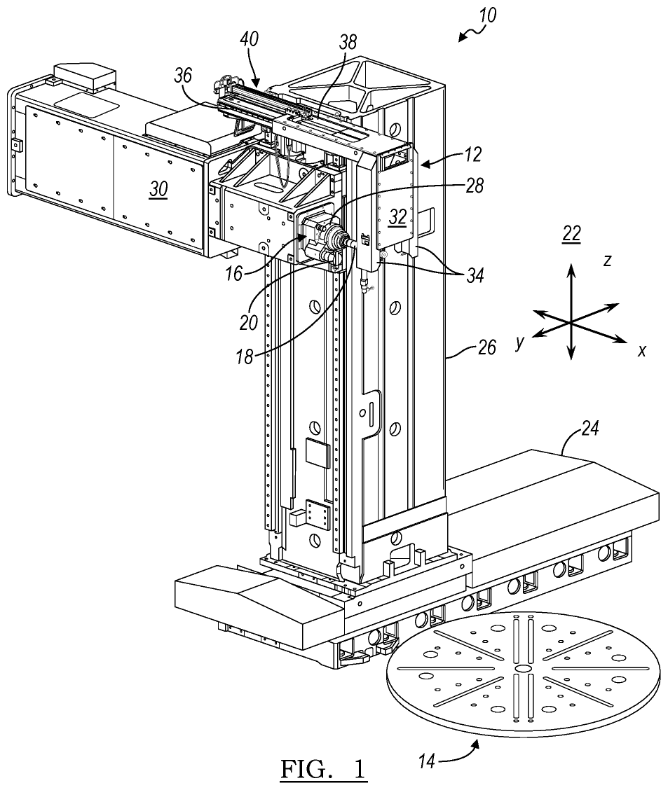

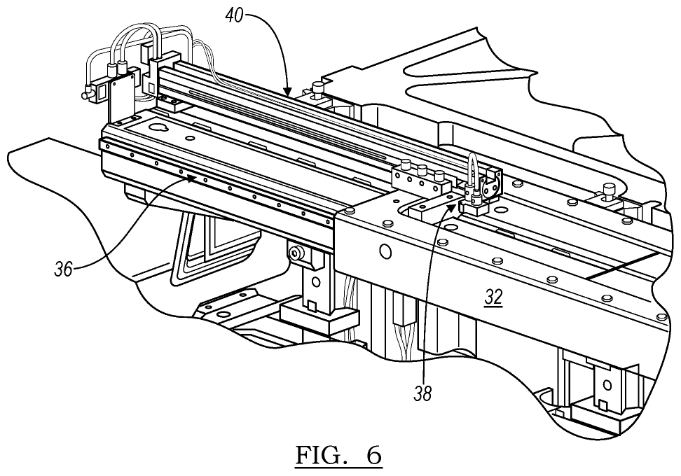

Turning to FIGS. 1-6, a mill-turn machine 10 is shown with a tool measurement assembly 12 slidably attached to the machine 10. The mill-turn machine 10 includes a table 14, for securely holding a workpiece, and a tool head 16 that can releasably hold a rotary cutting tool 18, a stationary cutting tool 20, or both, used to remove material from workpieces. The table 14 is in a workspace 22 where cutting or machining takes place and the mill-turn machine 10 can articulate the tool head 16 within the workspace 22 relative to the workpiece depending on the desired shape of the workpiece and the machining to be carried out. The mill-turn machine 10 can include a base 24 on which a column 26 is slidably attached to move in a y-direction and a z-direction. A headstock 30 can be slidably attached to the column 26 via a carriage that moves along a z-direction and can move the tool head 16 in an x-direction. The tool head 16 can be coupled with a distal end of a ram 49. The ram 49 can slidably articulate the tool head 16 and position it in an x-direction to carry out different machining functions, such as turning operations or milling operations. The machine 10 can include the stationary cutting tool 20 having a cutting edge used for turning the workpiece using the table 14 that rotates the workpiece. Examples of stationary cutting tools include turning tools, chamfering tools, or boring bars. The machine 10 can also include a spindle 18 that rotates the rotary cutting tool 18 for milling the workpiece while it is held on the table 14. Both the rotary cutting tool 18 and the stationary cutting tool 20 can be releasably held by the tool head 16 using tool holders that close to hold the cutting tool and open to release the tool.

The machine 10 can include an automatic tool changer that, in coordination with the tool holders holding the cutting tools 18, 20, can replace either tool held by the tool head 16 without manual user assistance.

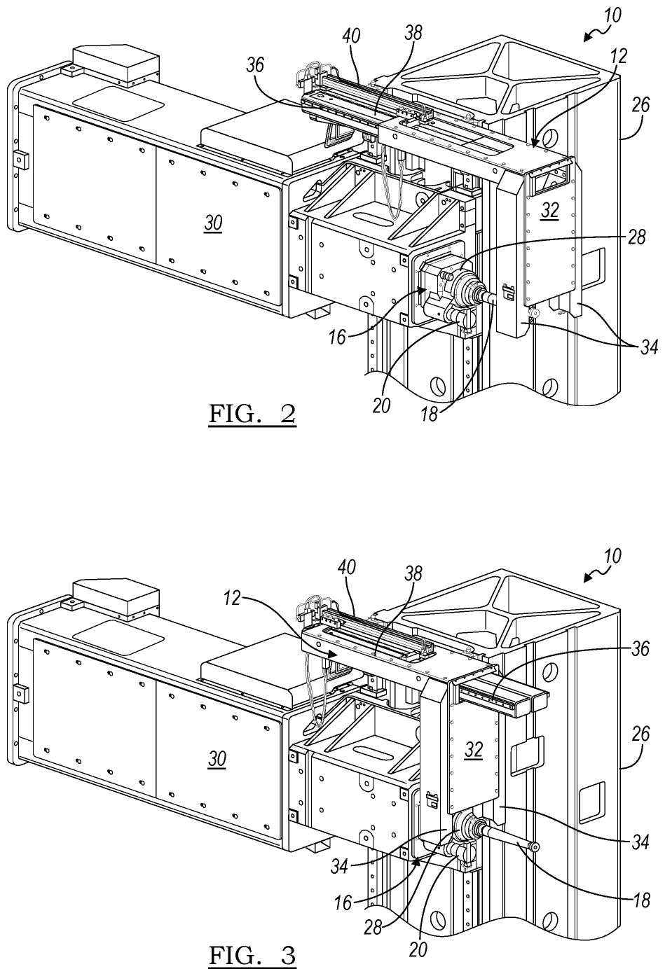

The tool measurement assembly 12 can include a yoke 32 having elongated sides 34 that can straddle a spindle 28 with a rotary cutting tool 18 and/or a stationary cutting tool 20. The tool measurement assembly 12 can be supported via a rail 36 such that the assembly 12 can move linearly between a deployed position, shown in FIG. 2, and a retracted position, shown in FIG. 3. The rail 36 connecting the tool measurement assembly 12 to the mill-turn machine 10 can be attached to the column 26 such that the yoke 32 and the elongated sides 34 are centered about the tool head 16. The machine 10 can position the tool head 16, and ultimately the cutting tool(s), between the sides 34 for measurement. A proximity sensor or encoder 38, electrically connected to a microprocessor (not shown), can accurately measure the position of the yoke 32 at its measurement position. An actuator 40, such as a pneumatic piston, can move the yoke 32 linearly along the rail 36. The rail 36 can have a length permitting travel of the assembly 12 beyond an end of the longest possible cutting tool held in the tool head 16.

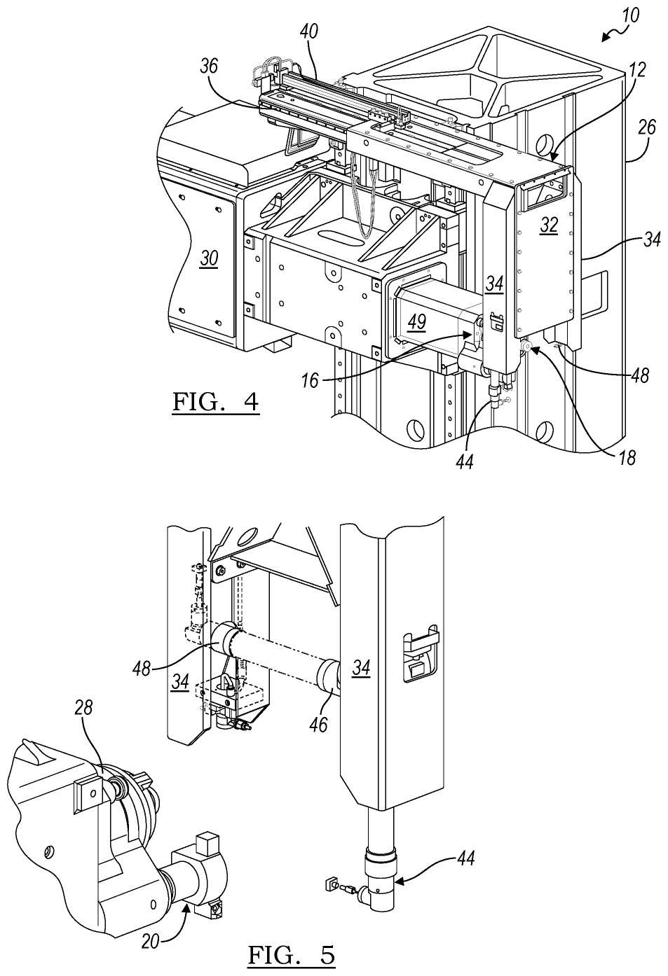

As part of measuring a cutting tool attached to the tool head 16, the tool measurement assembly 12 can be moved from the retracted or stowed position away from the workspace 22 to a deployed position in front of the longest tool. The yoke 32 can include a laser tool setter 42 and a physical stylus tool probe 44. The laser tool setter 42 may include a laser transmitter 46 coupled to one of the elongated sides 34 and a laser receiver 48 coupled to the other, opposite elongated side 34. The laser transmitter 46 and the laser receiver 48 can each be electrically connected to transmit a signal to a microprocessor. In addition, the physical stylus tool probe 44 can be moveably connected to one of the elongated sides 34. For example, the physical stylus tool probe 44 can be pivotably attached to the yoke 32 so that in a stowed position, as shown in FIGS. 2-3, the probe 44 is protected within the elongated side 34, but can be pivoted so that an end of the probe 44 moves in front of the tool head 16, as shown in FIGS. 4-5, so that it may be contacted by the stationary cutting tool 20 during the measurement process.

The mill-turn machine 10 can measure an outer surface of a cutting tool 18, 20 held by the tool head 16 by moving the tool measurement assembly 12 to the deployed position. The machine 10 can then select the laser tool setter 42 or the physical stylus tool probe 44 depending on whether the machine 10 is measuring a rotary cutting tool 18 or a stationary cutting tool 20, respectively. Measuring the rotary cutting tool 18 can involve activating the spindle 28 to turn the rotary cutting tool 18 and sending a laser beam from the transmitter 46 to the receiver 48. Measuring the stationary cutting tool 20 can include moving the physical stylus tool probe 44 to a deployed position. In either event, the mill-turn machine 10 can move the tool head 16 relative to the x-axis and the z-axis so that the cutting tool moves within the elongated sides 34 to facilitate measurement. Measurement can involve determining tool diameter and/or length. Once the measurement process is complete, the physical stylus tool probe 44 can pivot to a retracted position within the elongated sides 34 (if needed) and the tool measurement assembly 12 can be moved along the rail 36 to a stowed position such that the assembly 12 is away from the tool head 16 and outside of the workspace 22; machining can then proceed.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A tool measurement assembly for a mill-turn machine, comprising:
a laser tool setter having a laser transmitter that measures an outer surface of a rotary cutting tool held by the mill-turn machine; and
a physical stylus tool probe configured to contact a stationary cutting tool held by the mill-turn machine, wherein the tool measurement assembly is configured to mount to the mill-turn machine allowing the tool measurement assembly to move into a measurement position within a workspace.

2. The tool measurement assembly recited in claim 1, further comprising a laser receiver.

3. The tool measurement assembly recited in claim 1, further comprising a yoke having two elongated sides that carry the laser tool setter and the physical stylus tool.

4. The tool measurement assembly recited in claim 1, further comprising a rail that couples the tool measurement assembly to the mill-turn machine.

5. The tool measurement assembly recited in claim 1, further comprising a pivot that couples the physical stylus tool probe to the tool measurement assembly such that the physical stylus tool probe moves about the pivot away from the tool measurement assembly and toward a tool head.

6. The tool measurement assembly recited in claim 1, further comprising a proximity sensor or encoder for determining the position of the tool measurement assembly relative to the mill turn machine.

7. The tool measurement assembly recited in claim 1, further comprising a pneumatic actuator coupling coupled to the assembly and the mill-turn machine.

8. A tool measurement assembly for a mill-turn machine, comprising:
a yoke, including at least one elongated side, and a rail configured to couple with the mill-turn machine and permit the tool measurement assembly to move into a workspace;
a laser tool setter, attached to the yoke, having a laser transmitter and a laser receiver that measures an outer surface of a rotary cutting tool held by the mill-turn machine; and
a physical stylus tool probe, attached to the yoke, that retractably deploys to contact a stationary cutting tool held by the mill-turn machine.

9. The tool measurement assembly recited in claim 8, further comprising a pivot that couples the physical stylus tool probe to the tool measurement assembly such that the physical stylus tool probe moves about the pivot away from the tool measurement assembly and toward a tool head.

10. The tool measurement assembly recited in claim 8, further comprising a proximity sensor or encoder for determining the position of the tool measurement assembly relative to the mill turn machine.

11. The tool measurement assembly recited in claim 8, further comprising a pneumatic actuator coupled to the assembly and the mill-turn machine.
